(19) United States
(12) Patent Application Publication
(10) Pub. No.: US 2011/0140908 A1
(43) Pub. Date: Jun. 16, 2011

(54) WIRELESS SENSOR HAVING MULTIPLE POSSIBLE ANTENNA MOUNTING LOCATIONS

(75) Inventors: DANIAL L. KOSHT, GAYLORD, MI (US); MARK A. MANTUA, FREEPORT, IL (US); TODD HANSON, LORETTO, MN (US); JOHN K. TILLOTSON, PETOSKEY, MI (US)

(73) Assignee: HONEYWELL INTERNATIONAL INC., MORRISTOWN, NJ (US)

(21) Appl. No.: 12/635,354

(22) Filed: Dec. 10, 2009

(51) Int. Cl. G08C 15/06

(52) U.S. Cl. 340/870.02

(57) ABSTRACT

A wireless valve-position monitor includes a housing having a plurality of possible antenna module mounting ports. A position sensor is within the housing that interfaces to a movable portion of a process-control valve for providing a position detection signal that reflects a position of the process-control valve. A wireless transceiver system including a transceiver coupled to an antenna module is coupled to the position sensor for transmitting a wireless signal that communicates the position of the process-control valve. The antenna module is mounted to one of the plurality of possible mounting ports on the housing.

### FIELD

Disclosed embodiments relate generally to control or monitoring systems, and more specifically to sensing systems and methods of wireless monitoring or control.

### BACKGROUND

Processing facilities, such as manufacturing plants, chemical plants and oil refineries, are typically managed using process control systems. Valves, pumps, motors, heating/cooling devices, and other industrial equipment typically perform actions needed to process materials in the processing facilities. Among other functions, the process control systems often manage the use of the industrial equipment in the processing facilities.

In conventional process control systems, controllers are often used to control the operation of the equipment in the processing facilities. The controllers typically monitor the operation of the industrial equipment and/or the products or related materials through use of various sensors, and provide control signals to the equipment based on information retrieved from the various sensors. Wireless transmitters can be used with the sensors to provide data from the processing facility to a remotely located processor for evaluation of the data. The wireless transmitters are generally rigidly connected to various processing devices. In some arrangements (e.g., structures and the like in the path of transmission) or environmental conditions, for a given transmitted power level the signal strength of the data signal received at the processor or other remote receiver can be insufficient for accurate evaluation of the data required for proper control. Moreover, in certain applications, such as battery powered sensor arrangements, it may not be possible to increase the transmitted power level to compensate for poor received signal strength.

### SUMMARY

Disclosed embodiments described herein include wireless valve-position monitors that comprise a housing comprising a plurality of possible antenna module mounting ports. In contrast, conventional wireless valve-position monitors comprise a single antenna module mounting port that fixes the location of the antenna relative to the housing. A position sensor is within the housing that interfaces to a movable portion of a process-control valve for providing a position detection signal that reflects a current position of the process-control valve. A wireless transmitter comprising a transceiver coupled to an antenna module is coupled to the position sensor for transmitting a wireless signal that communicates the position of the process-control valve, such as to a network. The antenna module may be mounted to one of the plurality of possible mounting ports which allows a user the ability to select from multiple different antenna mounting locations, such as to provide improved communications (e.g., higher received signal levels) with a remote location. Moreover, the ability to select from multiple different antenna mounting locations allows antenna module location flexibility that enables use in applications that are not possible with conventional valve-position monitors in which a portion of the valve to be measured occupies the same space as the sole antenna module mounting location provided.

### BRIEF DESCRIPTION OF THE DRAWINGS

FIG. 1 is depiction of an exemplary wireless valve-position monitor, according to a disclosed embodiment.

FIG. 2 is simplified depiction of a housing for a wireless valve-position monitor having a plurality of threaded mounting ports oriented along the x-y plane, and plurality of threaded mounting ports oriented along the z axis, according to a disclosed embodiment.

FIG. 3A is a depiction of a wireless valve-position monitor that includes an infrared (IR) port within the housing, according to a disclosed embodiment.

FIG. 3B is a depiction of a wireless valve-position monitor includes an IR port within the antenna module, according to another disclosed embodiment.

FIG. 4 is a schematic illustration of an exemplary monitoring system comprising a plurality of wireless valve-position monitors, according to a disclosed embodiment.

FIG. 5 shows a cutaway view of a ball valve that includes a rotating target magnet attached to a valve stem and a wireless valve-position monitor attached to the ball valve that includes an MR sensor which measures the magnetic flux and hence the angular position of the ball valve.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate the disclosed embodiments. Several aspects disclosed herein are described below with reference to example applications for illustration. It should be understood that numerous specific details, relationships, and methods are set forth to provide a full understanding of the disclosed embodiments and their equivalents. One having ordinary skill in the relevant art, however, will readily recognize that the disclosed embodiments can be practiced without one or more of the specific details or with other methods. In other instances, well-known structures or operations are not shown in detail to avoid obscuring aspects of the disclosed embodiments. Disclosed embodiments are not limited by the illustrated ordering of acts or events, as some acts may occur in different orders and/or concurrently with other acts or events. Furthermore, not all illustrated acts or events are required to implement a methodology in accordance with the disclosed embodiments of their equivalents.

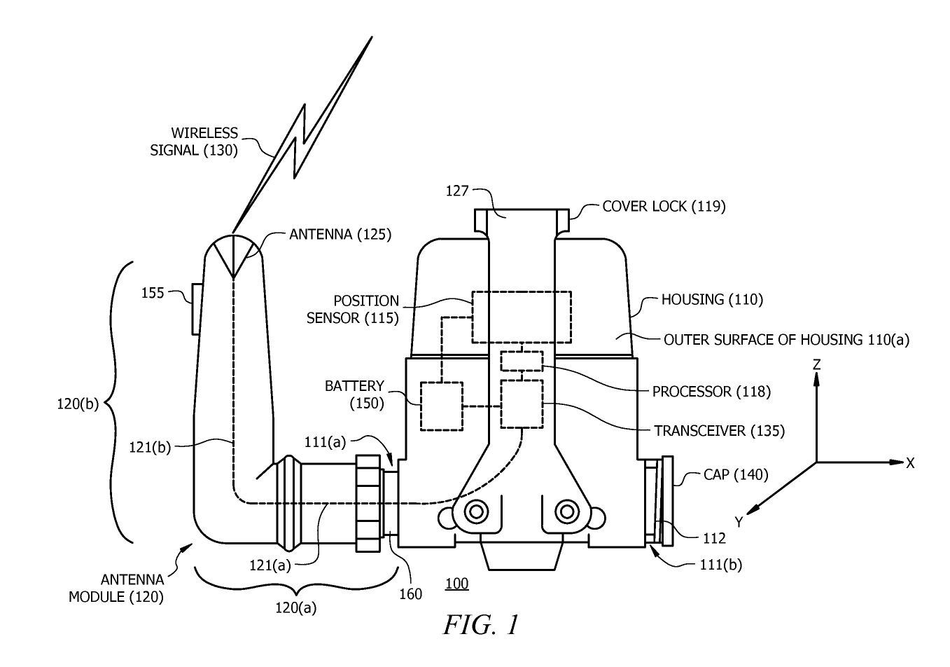

FIG. 1 is a depiction of an exemplary wireless valve-position monitor 100, according to a disclosed embodiment. Wireless valve-position monitor 100 can be embodied to sense either linear or rotary valve positions. Wireless valve-position monitor 100 comprises a housing 110 that comprises a plurality of possible antenna module mounting ports, shown in FIG. 1 as antenna module mounting ports 111(a) and 111(b). By providing a plurality of possible antenna module mounting ports disclosed embodiments overcome the deficiency recognized by the Inventors that for certain applications a fixed antenna mounting location relative to the housing may result in degraded received signal strength between the wireless valve-position monitors and a remote location, even if the antenna orientation is adjustable (e.g., swivels).

Housing 110 is shown including a cover lock 119 coupled to a removable cover 127 that allows access to housing 110, such as to change the battery (e.g., lithium battery) 150 that is within the housing 110. As shown in FIG. 1, mounting ports 111(a) and 111(b) are both oriented along the x-y plane. A position sensor 115 is within the housing 110 that interfaces to a movable portion (e.g., valve stem) of a process-control valve (not shown in FIG. 1) for providing a position detection signal that reflects a current position of the process-control valve.

The position sensor 115 can comprise various sensor types, such as an optically-based sensor, a potentiometer, a variable capacitor, or a magnetoresistive (MR) sensor. The MR sensor embodiment affixes a target magnet to the valve stem and the MR sensor measures the angular position of the valve stem by measuring the changing magnetic flux of the target magnet while the target magnet is rotating. MR sensors can comprise magneto-resistive (GMR) sensors, anisotropic magneto-resistive (AMR) sensors, colossal magnetoresistive sensors or tunneling magnetoresistive sensors that are generally configured as Wheatstone bridge circuits.

A processor (e.g., a microprocessor or microcontroller) 118 is coupled to the output of the position sensor 115. The processor 118 is shown coupled to transceiver 135. The transceiver 135 typically includes a transmitter circuit and a receiver circuit which cooperate to transmit and receive radio signals to and from a remote location via antenna 125.

A wireless transceiver system as used herein comprises the transceiver 135 together with the antenna module 120. The antenna module 120 comprises conductors 121(a) and 121(b) that are coupled to an antenna element 125, wherein the antenna module 120 is mounted to one of the plurality of possible mounting ports on the housing 110, shown in FIG. 1 mounted to antenna module mounting port 111(a). Both antenna module mounting ports 111(a) and 111(b) are located on the outer surface 110(a) of the housing 110.

The antenna module 120 is shown including a connector 160 that mates with the plurality of possible antenna mounting ports connected to antenna module mounting port 111(a), such as by including coaxial boring and threading to mate with the threading 112 associated with antenna module mounting port 111(b) shown in FIG. 1. The antenna module 120 is shown comprising a first antenna module portion 120(a) includes an electrical conductor (e.g., coaxial connector) 121(a) therein that is parallel to an axis of the connector 160, and the second antenna module portion 120(b) that includes a conductor (e.g., coaxial connector) 121(b) therein that is disposed at an off-axis angle (shown as being 90 degrees in FIG. 1) relative to the axis of the connector 160.

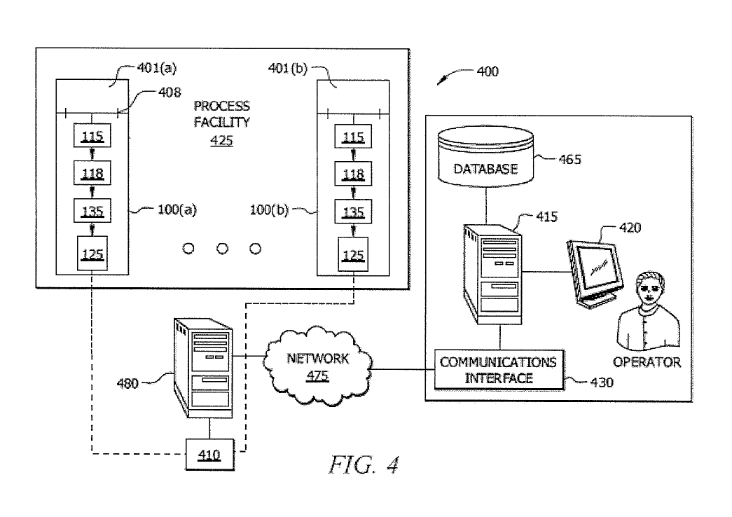

Antenna 125 is coupled to a distal end of conductor 121(b) and while transmitting transmits the wireless signal 130 shown in FIG. 1, which is generally an RF signal. Antenna 125 can generally comprise any antenna style, such as dipole, monopole, and Yagi-Uda. The wireless signal 130 generally includes an identifier that can uniquely identify the wireless valve-position monitor so that a system including a plurality of wireless valve-position monitors 100, such as system 400 described below relative to FIG. 4, can recognize the particular valve associated with each of the respective wireless signals.

The connector 160 is generally configured to permit the antenna module 120 and thus antenna 125 to be rotated with respect to the housing 110, such as rotated to identify an orientation that maximizes a receive signal strength at a remote location, for example, a network. A variety of rotatable connections may be used, such as the rotatable connection disclosed in U.S. Pat. No. 7,595,763 to Hershey, et al. assigned to Honeywell International.

The antenna module 120 can include one or more visual indicators 155 (LEDs for example) that illustrate a given state, change in state, or alert. Such indicators 155 can be displayed continuously, at given time intervals (programmed or preset), or conditionally activated through an electronics command (e.g., given wireless or through physical electronic signal). One use for visual indicators 155 is to indicate the signal strength of the received transmission at a remote location such as a network to allow an installer of wireless valve-position monitor 100 to identify the best mounting location and optionally the best orientation of the antenna module 120 for signal strength.

A sealing cap 140 may be placed over the antenna module mounting port(s) that are not in current use, such as antenna module mounting port 111(b) shown in FIG. 1. The battery 150 within the housing 110 provides power to the various components of the wireless valve-position monitor 100 (connection to visual indicators 155 is not shown).

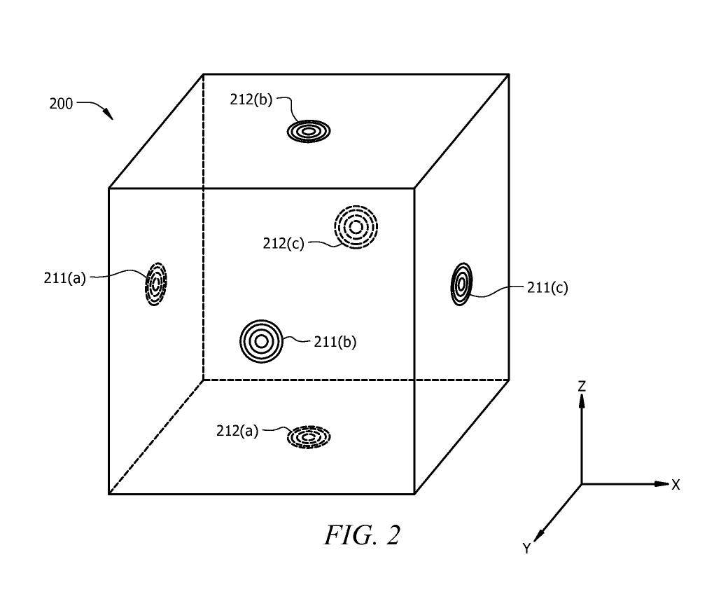

FIG. 2 is a simplified depiction of a housing 200 of a wireless valve-position monitor having a plurality of threaded mounting ports 211(a), 211(b) and 211(c) oriented along the x-y plane, and plurality of threaded mounting ports 212(a), 212(b) and 212(c), oriented along the z axis, according to a disclosed embodiment. Antenna modules, such as antenna module 120 shown in FIG. 1, can be mounted in any of the threaded antenna mounting ports shown for coupling to an antenna provided by antenna module.

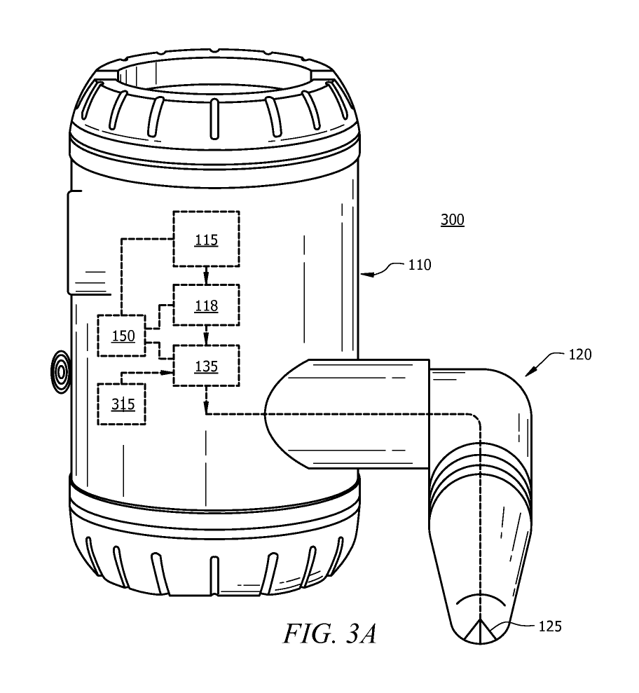

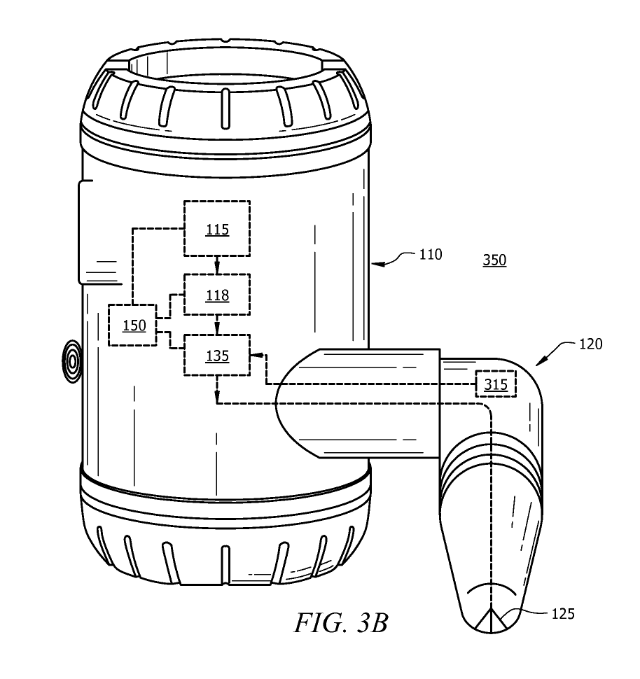

FIG. 3A is a depiction of a wireless valve-position monitor 300 that includes an IR port 315 within the housing 110, according to a disclosed embodiment. IR port 315 includes IR communication electronics comprising an IR receiver which can be installed within the housing 110 to facilitate intrinsically safe over the air point-to-point serial communication of data. The IR communication can eliminate the need to directly access the transceiver 135 for programming that cannot be accomplished with RF signals.

In another disclosed embodiment shown in FIG. 3B, a wireless valve-position monitor 350 includes an IR port within the antenna module 120, according to a disclosed embodiment. In this embodiment the antenna module 120 is formed from an IR transparent material. Although present, connection from the battery 150 to transceiver 315 is not shown in FIG. 3B.

Disclosed wireless valve-position monitor can be installed on valves, such as a ball valve, even while the valve is currently in service. One attachment comprises a supporting element is attached to the body of the ball valve by one or more fasteners, such as screws. The supporting element is positioned so that the operation of the valve is not affected. As described below, in a typical application, a plurality of wireless valve-position monitor are installed on valves within a process facility to form a network. Each wireless valve-position monitor communicates with one or more central units and optionally other devices, or using a suitable wireless protocol.

FIG. 4 is a schematic illustration of an exemplary controlled valve-comprising system 400 comprising a plurality of wireless valve-position monitors 100(a) and 100(b) attached by fasteners 408 to valves 401(a) and 401(b), according to a disclosed embodiment. Controlled valve-comprising system 400 can be used with various processing facilities and various processes, such as manufacturing processes, chemical plants and oil refineries. The particular type of facility and the particular type of process that is to be controlled is not intended to be limited. Controlled valve-comprising system 400 can provide control of a multi-variable process. In one embodiment, the controlled valve-comprising system 400 can be applied to a non-linear process, but disclosed embodiments include the use of the controlled valve-comprising system 400 for implementing control in linear processes as well.

The controlled valve-comprising system 400 is shown including a controller 415 that makes use of computing technology, such as a desktop computer or scalable server, for controlling operations of the controlled valve-comprising system 400 with respect to one or more process facilities 425 (only one shown). The controller 415 can allow for operator access to the controlled valve-comprising system 400, including operator intervention when desired. The controlled valve-comprising system 400 can also include a communications interface 430 that can utilize common technology for communicating, such as over a network 475, with a server 480.

The monitoring system 400 can further include a memory 465 (such as a high capacity storage medium) embodied in this illustration as a database 465. The network 475 can be various types and combinations of networks, such as wired and/or wireless networks, including a Local Area Network (LAN). The server 480 can be a client's device, such as a customer premises device, having a wireless communications device 410 (e.g., transmitter, receiver, or transceiver) allowing wireless communication with one or more wireless valve-position monitors 100 comprising transmitters, receivers or transceivers of the process facility 425 using various wireless protocols, such as Radio Frequency (RF) transmissions, IR transmissions, Wireless Fidelity (WiFi), Worldwide Interoperability for Microwave Access (WiMAX), Ultra Wide Band (UWB), software defined radio (SDR), cellular access technologies including CDMA-1X, W-CDMA/HSDPA, UMTS, GSM/GPRS, TDMA/EDGE, FDMA, DSSS, FHSS and EVDO, and cordless phone technology (e.g., DECT), BLUETOOTH™.

Wireless valve-position monitors 100(a) and 100(b) can be used to transmit sensor data to a remotely located receiver and receive data from a remotely located transmitting device, such as wireless communications device 410. By mounting antenna module 120 to the particular one of the plurality of antenna mounting ports provided allows controlled valve-comprising system 400 to operate with improved signal strength as compared to conventional controlled valve-comprising systems that provide a single antenna mounting port. Thus, disclosed wireless valve-position monitors can increase the transmitted signal strength (to some remote receiver), and also the received signal strength at the wireless valve-position monitor.

In one embodiment, the controlled valve-comprising system 400 can operate as a distributed control system (DCS) conforming in part to protocols defined by standards bodies, such as the OPC. In another embodiment, the controller 415 can operate utilizing a broad range of client, server and redundancy OPC technologies.

In yet another embodiment, the controller 415 can include an EXPERION™. Process Knowledge System (PKS) that utilizes OPC standards to provide data from the data source and communicates the data to any client application in a standard way, thereby eliminating the requirement for an application to have specific knowledge about a particular data source, such as its internal structure and communications protocols.

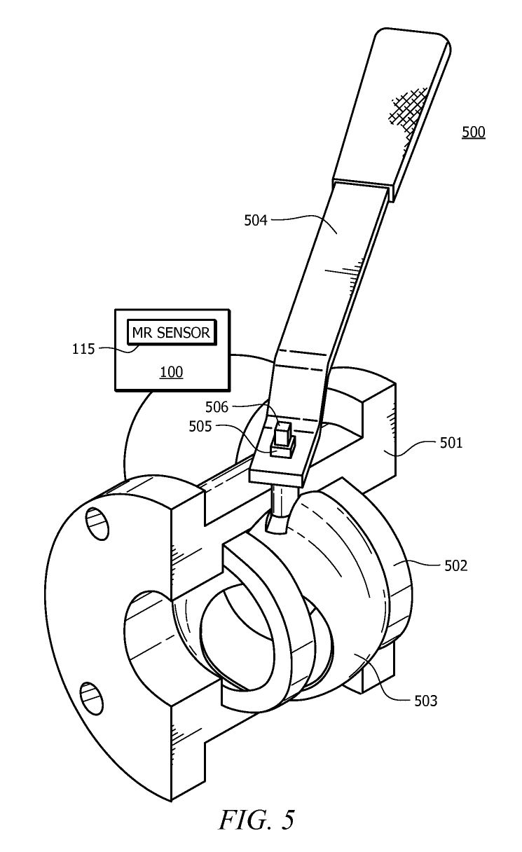

FIG. 5 shows a cutaway view of a ball valve 500 that includes a rotating target magnet 506 attached to a valve stem 505 and a wireless valve-position monitor 100 attached to the ball valve 500 that includes an MR sensor 115 which measures the magnetic flux and hence the angular position of the ball valve 500. The valve body is indicated as 501, the head as 502, the ball as 503, the lever handle as 504 and the valve stem as 505. Target magnet 506 is affixed to the valve stem 505. Movement of the lever handle 504 moves the angular position of the valve stem 505 which rotates target magnet 506, which is sensed from 0 to 360 degrees in a non-contact manner by MR sensor 115. In this embodiment, the housing 110 for wireless valve-position monitors 100 comprises a material that permits magnetic flux penetration (i.e. a non-ferromagnetic material).

A method of process control using at least one wireless valve-position monitor comprising a housing having a plurality of possible antenna module mounting ports including a first and at least a second mounting port is now disclosed. A position sensor is within the housing that interfaces to a movable portion of a valve for providing a position detection signal that reflects a position of said valve, and a wireless transceiver system comprising a transceiver is coupled to an antenna module that is coupled to the position sensor for transmitting a wireless signal that communicates the position of the valve to a wireless communications device coupled to a controller remotely positioned from the wireless valve-position monitor.

A first signal strength of the wireless signal is measured at the wireless communications device while the antenna module is mounted to the first mounting port. The antenna module is removed from the first mounting port and is then mounted in the second mounting port. A second signal strength of the wireless signal is measured while the antenna module is mounted to the second mounting port. It is then determined which of the plurality of different antenna mounting locations to mount the antenna module from the first and second signal strength. The antenna module can further comprise at least one visual indicator, and the visual indicator can be used to provide an indication of the first and said second signal strength.

In order to facilitate installation of disclosed wireless valve-position monitors, in one embodiment the antenna module can include an RF coaxial cable and connector having a conduit hole. The antenna module could then be physically installed on any of the plurality of antenna mount locations with the coaxial cable protruding into the conduit hole. The conduit hole can be configured such that it would extinguish any flame internal to the cavity prior to an escape through the thread path. The coaxial cable could then be connected either directly to the radio transmitter or to an intermediary junction mounted on a bulkhead (or similar) that facilitates the connection to transmitter and the antenna (i.e. a bulk mount connector).

Disclosed valve position sensors can be used in a wide variety of applications to monitor the position of valves, and can send sensing wireless signals from remote or potentially dangerous areas of the process facility, such as a plant. The sensing signal can carry appropriate hazardous location certifications, which makes disclosed valve position sensors ideal for various applications such as monitoring valve positioner status, manual process valve position, safety shower and eye bath notification, tank overflow alarms, damper and louver position, door/gate position, or other applications where installing wires is inefficient, cost-prohibitive, or simply unsafe.

While various embodiments have been described above, it should be understood that they have been presented by way of example only, and not limitation. Numerous changes to the disclosed embodiments can be made in accordance with the disclosure herein without departing from the spirit or scope of the disclosed embodiments. Thus, the breadth and scope of the disclosed embodiments should not be limited by any of the above explicitly described embodiments. Rather, the scope of the invention should be defined in accordance with the following claims and their equivalents.

Although the disclosed embodiments have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting to embodiments of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which the disclosed embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the following claims.

1. (canceled)

2. The wireless position monitor of claim 21, wherein said antenna module further comprises at least one visual indicator.

3. The wireless position monitor of claim 2, wherein said visual indicator comprises a laser or light emitting diode (LED), wherein an intensity of light from said laser or LED corresponds to a signal strength of said wireless sensing signal received at a remote location.

4. The wireless position monitor of claim 21, further comprising a battery in said housing for providing power to electrical components in said wireless position monitor.

5. The wireless position monitor of claim 21, wherein said wireless signal further comprises an identifier that identifies said wireless position monitor.

6. The wireless position monitor of claim 21, wherein said position sensor comprises a magnetoresistive (MR) sensor.

7. The wireless position monitor of claim 21, wherein said antenna module further comprises a connector that mates with the one of said plurality of possible antenna mounting ports and comprises at least a first antenna module portion and a second antenna module portion; wherein said first antenna module portions includes a conductor that is oriented parallel to an axis of said connector, and the second antenna module portion includes a conductor that is disposed at an off-axis angle relative to said axis of said connector.

8. The wireless position monitor of claim 21, wherein said wireless position monitor further comprises an IR Port coupled to said wireless transceiver for point to point serial communication of data.

9. The wireless position monitor of claim 8, wherein said IR port is disposed within said antenna module and said antenna module is formed from an IR transparent material.

10. The wireless position monitor of claim 21, further comprising a sealing cap disposed in each of the plurality of antenna module mounting ports other than the one to which said antenna module is mounted.

11. (canceled)

12. The system of claim 22, wherein said antenna module further comprises at least one visual indicator comprising a laser or light emitting diode (LED), wherein an intensity of light from said laser or LED corresponds to a signal strength of said wireless signals received at said wireless communications device.

13. The system of claim 22, said wireless signal further comprises an identifier that identifies respective ones of plurality of wireless valve-position monitors.

14. The system of claim 22, wherein said plurality of devices are valves that each include a target magnet affixed thereto, and wherein said position sensors comprise magnetoresistive (MR) sensors.

15. The system of claim 22, wherein said antenna modules further comprise a connector that mates with the one of said plurality of possible antenna mounting ports and comprises at least a first antenna module portion and a second antenna module portion; wherein said first antenna module portions includes a conductor that is oriented parallel to an axis of said connector, and the second antenna module portion includes a conductor that is disposed at an off-axis angle relative to said axis of said connector.

16. The system of claim 22, wherein said wireless position monitors further comprise an IR Port coupled to said wireless transceiver system for point to point serial communication of data.

17. The system of claim 16, wherein said IR port is disposed within said antenna module and said antenna module is formed from an IR transparent material.

18. (canceled)

19. The method of claim 23, wherein said antenna module further comprises at least one visual indicator, and wherein said visual indicator provides an indication of said signal strength.

20. (canceled)

21. A wireless position monitor, comprising:
a housing comprising a plurality of antenna module mounting ports;
a position sensor disposed within said housing, the position sensor adapted to interface to a movable portion of a device and configured to supply a position detection signal representative of a position of said device;
a wireless transceiver coupled to receive the position detection signal from said position sensor and configured to generate a wireless signal that includes at least a signal representative of the position detection signal; and
an antenna module mounted to one of said antenna module mounting ports, the antenna module comprising an antenna element coupled to said transceiver and configured to emit the wireless signal.

22. A control system, comprising:
a wireless communications device configured to communicate with a remotely located controller, the wireless communications device further configured to receive and process wireless signals and to transmit wireless control signals; and
a plurality of wireless position monitors configured to supply the wireless signals to, and receive the wireless control signals from, the wireless communications device, each of said wireless position monitors comprising:
a housing comprising a plurality of antenna module mounting ports;
a position sensor disposed within said housing and adapted to interface to a movable device, the position sensor configured to supply a position detection signal representative of a position of said movable device; and
a wireless transceiver coupled to receive the position detection signal from said position sensor and configured to generate a wireless signal, the wireless signal including at least a signal representative of the position detection signal; and
an antenna module mounted to one of said antenna module mounting ports, the antenna module comprising an antenna element coupled to said transceiver and configured to emit the wireless signal and receive a wireless control signal.

23. A method of determining a preferred antenna module mounting location for a wireless position monitor that includes a housing having a plurality of antenna module mounting ports and a wireless position sensing and transmission system disposed within the housing, the wireless position sensing and transmission system comprising a transceiver configured to generate a wireless signal and an antenna module that includes an antenna element coupled to the transceiver and configured to emit the wireless signal, the method comprising the steps of:
individually mounting said antenna module to each of said plurality of different antenna module mounting ports;
while said antenna module is individually mounted in each of said plurality of different antenna module mounting ports, measuring a signal strength of said wireless signal at a remote location;
determining a preferred antenna module mounting port from said plurality of different antenna module mounting ports based on the measured signal strengths; and
mounting said antenna mounting port to the preferred antenna module mounting port.
